(19) United States
(12) Patent Application Publication
(10) Pub. No.: US 2025/0307094 A1
(43) Pub. Date: Oct. 2, 2025

(54) METHOD, DEVICE, AND COMPUTER PROGRAM PRODUCT FOR ASSIGNING TEST DEVICE

(71) Applicant: Dell Products L.P., Round Rock, TX (US)

(72) Inventors: Huijuan Fan, Chengdu (CN); Jun Liu, Chengdu (CN); Changxu Jiang, Chengdu (CN)

(21) Appl. No.: 18/638,298

(22) Filed: Apr. 17, 2024

(30) Foreign Application Priority Data
Mar. 26, 2024 (CN) 202410353391.9

(51) Int. Cl. G06F 11/22

(52) U.S. Cl. CPC G06F 11/2215

(57) ABSTRACT

The present disclosure relates to a method, a device, and a computer program product for assigning a test device. The method includes determining a usage status of the test device in response to the test device being occupied. The method further includes determining a health status of the test device in response to the usage status of the test device indicating that the test device has not been used for more than a predetermined time period. The method further includes marking the test device as unoccupied and healthy in response to the health status of the test device indicating that the test device is healthy. In addition, the method further includes assigning the test device to a test case. In this way, wastage of test device resources can be reduced, the utilization rate of the device can be improved, and the efficiency of an entire test team can be improved.

### RELATED APPLICATION

The present application claims priority to Chinese Patent Application No. 202410353391.9, filed Mar. 26, 2024, and entitled “Method, Device, and Computer Program Product for Assigning Test Device,” which is incorporated by reference herein in its entirety.

### FIELD

The present disclosure relates to the field of software testing, and more particularly to a method, device, and computer program product for assigning a test device.

### BACKGROUND

Test case execution refers to a process of actual test operation and verification of software according to predefined test case specifications and steps. Test cases are a set of instructional documents or scripts, which contain a series of test steps, input data, and comparison methods for expected results and actual results. Test case execution is a very important step in the process of software testing, which aids in finding potential defects, verifying whether the software meets the specifications and user demands, and evaluating the performance and reliability of the software.

A test device refers to various hardware devices used in the process of software testing to verify the function, performance, and compatibility of the software in different environments. The selection of the test device depends on factors such as the type of software to be tested, the target platform, and the user group, so as to ensure that the software can run normally in various practical use situations. When executing a test case, test engineers use a test device to verify the reliability and effectiveness of the test case. By executing the same test case on different test devices, the behavior consistency of the software in various hardware environments can be ensured, and potential compatibility problems or device-specific errors can be found.

### SUMMARY

In a first aspect of embodiments of the present disclosure, a method for assigning a test device is provided. The method includes determining whether the test device is occupied. The method further includes determining a usage status of the test device in response to the test device being occupied. The method further includes determining a health status of the test device in response to the usage status of the test device indicating that the test device has not been used for more than a predetermined time period. The method further includes marking the test device as unoccupied and healthy in response to the health status of the test device indicating that the test device is healthy. In addition, the method further includes assigning the test device to a test case.

In a second aspect of embodiments of the present disclosure, an electronic device is provided. The electronic device includes at least one processor; and a memory coupled to the at least one processor and having instructions stored therein. The instructions, when executed by the at least one processor, cause the electronic device to perform actions including determining whether the test device is occupied. The actions further include determining a usage status of the test device in response to the test device being occupied. The actions further include determining a health status of the test device in response to the usage status of the test device indicating that the test device has not been used for more than a predetermined time period. The actions further include marking the test device as unoccupied and healthy in response to the health status of the test device indicating that the test device is healthy. In addition, the actions further include assigning the test device to a test case.

In a third aspect of embodiments of the present disclosure, a computer program product is provided. The computer program product is tangibly stored on a non-transitory computer-readable medium and comprises machine-executable instructions. The machine-executable instructions, when executed by a machine, cause the machine to perform actions including determining whether the test device is occupied. The actions further include determining a usage status of the test device in response to the test device being occupied. The actions further include determining a health status of the test device in response to the usage status of the test device indicating that the test device has not been used for more than a predetermined time period. The actions further include marking the test device as unoccupied and healthy in response to the health status of the test device indicating that the test device is healthy. In addition, the actions further include assigning the test device to a test case.

It should be understood that the content described in this Summary is neither intended to define key or essential features of embodiments of the present disclosure, nor intended to limit the scope of the present disclosure. Other features of the present disclosure will become readily understood from additional description provided herein.

### BRIEF DESCRIPTION OF THE DRAWINGS

The above and other features, advantages, and aspects of embodiments of the present disclosure will become more apparent with reference to the accompanying drawings and the following Detailed Description. In the accompanying drawings, identical or similar reference numerals represent identical or similar elements, in which:

FIG. 1 shows a schematic diagram of an example environment in which multiple embodiments of the present disclosure can be implemented;

FIG. 2 shows a flowchart of a method for assigning a test device according to some embodiments of the present disclosure;

FIG. 3 shows a schematic diagram of an example architecture for test device management according to some embodiments of the present disclosure;

FIGS. 4A-4C show flowcharts of an example process of monitoring the status of the test device by a test device status monitoring module according to some embodiments of the present disclosure;

FIG. 5 shows a flowchart of an example process of matching the test devices and the test cases by a test device filtering module for test matching according to some embodiments of the present disclosure;

FIG. 6 shows a flowchart of an example process of handling a reservation request by a test device reservation module according to some embodiments of the present disclosure; and

FIG. 7 shows a block diagram of a device that can implement multiple embodiments of the present disclosure.

### DETAILED DESCRIPTION

Illustrative embodiments of the present disclosure will be described below in further detail with reference to the accompanying drawings. Although the accompanying drawings show some embodiments of the present disclosure, it should be understood that the present disclosure may be implemented in various forms, and should not be construed as being limited to the embodiments stated herein. Rather, these embodiments are provided for understanding the present disclosure more thoroughly and completely. It should be understood that the accompanying drawings and embodiments of the present disclosure are for exemplary purposes only, and are not intended to limit the scope of protection of the present disclosure.

In the description of embodiments of the present disclosure, the term “include” and similar terms should be understood as open-ended inclusion, that is, “including but not limited to.” The term “based on” should be understood as “based at least in part on.” The term “an embodiment” or “the embodiment” should be understood as “at least one embodiment.” The terms “first,” “second,” and the like may refer to different or identical objects. Other explicit and implicit implementations may also be included below.

In a Software Testing Life Cycle (STLC) and an entire software development process, test case execution is a crucial stage. As software regeneration is increasingly speeding up, and the requirements for agile testing are getting increasingly higher, it is usually necessary to execute a large number of test cases in a short time before software release to maximize test coverage. However, it is often a challenge for test engineers to complete the execution of all test cases on time because of various unexpected obstacles during testing, such as the failure of a test device (e.g., array, host, switch, etc.). Therefore, test engineers need to effectively manage and coordinate all kinds of devices and reasonably arrange the execution order of test cases, otherwise these problems may lead to a slow test progress, thus affecting the timely and high-quality release of products.

At present, there are mainly two device management methods for test teams. One method is to assign a fixed test device to a test engineer, which can ensure that each device has a fixed user, thus ensuring that the test engineer is responsible for the maintenance and management of the device assigned to him. However, this method requires a lot of test device resources, otherwise it is impossible to meet the demand of some devices with special configuration. In addition, as the devices are fixedly assigned to specific engineers, the engineers cannot flexibly share these devices. Another method is to establish a test device pool shared by all engineers, and the engineers can occupy the test devices on a first-come-first-served basis. After a test is completed, an engineer needs to manually release the occupied devices. However, although this method allows the engineers to choose required devices freely, it lacks a mechanism to optimize the device assignment scheme according to different test cases, which leads to the frequent shortage of some test devices with special configuration that may be used to run some common test cases, while those test cases with special requirements for device configuration may always be in a status of queuing up to wait, which will affect the overall test progress.

In some scenarios, an engineer cannot know the health status of a test device, so the case may occur where when applying for a device with a configuration and obtaining the right to use the applied device after waiting for a period of time, the assigned device is found to be faulty. A common countermeasure is that the engineer applies for multiple test devices with the same configuration at the same time in case there is a faulty device, which causes resource wastes. In addition, engineers often forget to release a test device after using it, or deliberately occupy the device for a long time for the next test, which makes other engineers unable to acquire the needed resources in time.

To this end, embodiments of the present disclosure provide a solution for assigning a test device. This solution can determine whether the test device is occupied, and if the test device is being occupied, the usage status of the test device can be determined. If the usage status of the test device indicates that the test device has not been used for a long time, the device can be forcibly released and the health status of the device can be determined. If the health status of the device indicates that it is healthy, the device can be marked as unoccupied and healthy. Then, this device can be assigned to the test case that needs it. In this way, it can be ensured that the test device assigned to the engineer is healthy, so that engineer does not need to apply for a redundant device to ensure that he/she can get a healthy device, thus reducing the waste of resources. In addition, this method can automatically release those occupied test devices that have not been used for a long time, thus increasing the mobility of the devices, improving the utilization rate of the devices, and improving the efficiency of the whole test team.

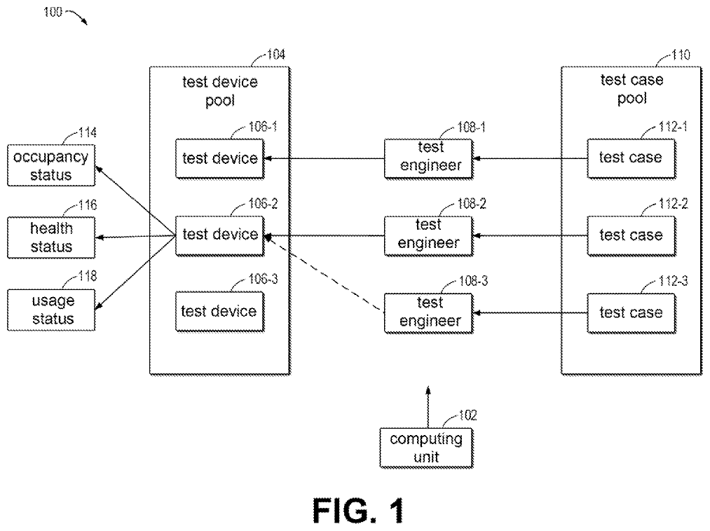

FIG. 1 shows a schematic diagram of an example environment 100 in which multiple embodiments of the present disclosure can be implemented. As shown in FIG. 1, the environment 100 includes a computing unit 102, which may be any device with computing power or processing power. For example, the computing unit 102 may be a remote server, a local server, a desktop computer, a laptop computer, a tablet computer, a mobile device, and the like. The environment 100 includes a test device pool 104, which may include multiple test devices, such as test devices 106-1, 106-2, and 106-3 (collectively referred to as test devices 106). The test device pool 104 can centrally manage all the test devices 106, including the number, model, configuration, status, and other information of the devices. The test team can find and manage the required test device 106 through the test device pool 104. The test device pool 104 can also support a pre-assignment optimization mechanism. For example, the computing unit 102 can automatically assign appropriate devices to the test engineers according to different test cases assigned to them.

As shown in FIG. 1, the environment 100 also includes test engineers 108-1, 108-2, and 108-3 (collectively referred to as test engineers 108) and a test case pool 110. The test case pool 110 generally includes various types of test cases, such as test cases 112-1, 112-2, and 112-3 (collectively referred to as test cases 112), which can cover different functional modules, user scenarios, and application scenarios of the software under test. The test cases 112 may comprise a document or script that describes the test scenario, steps, input data, expected results, and actual results to verify the function, performance, and reliability of the software in different conditions. The test case pool 110 can be organized and classified according to project demands and test strategies, so that the test team can conveniently select and execute appropriate test cases. In the example shown in the environment 100, the test case 112-1 is assigned to the test engineer 108-1, the test case 112-2 is assigned to the test engineer 108-2, and the test case 112-3 is assigned to the test engineer 108-3.

As shown in FIG. 1, the computing unit 102 can monitor various statuses of the test device 106. In the environment 100, the computing unit 102 can at least monitor the occupancy (or renting) status 114, the health status 116, and the usage status 118 of the test device 106. The occupancy status 114 may indicate whether the test device 106 is being occupied by the test engineer 108. For example, a value of “1” or “true” of the occupancy status 114 may indicate that the test device is being occupied, and a value of “0” or “false” of the occupancy status 114 may indicate that the test device is not occupied. For example, as shown in the environment 100, the test device 106-1 is being occupied by the test engineer 108-1, the test device 106-2 is being occupied by the test engineer 108-2, and the test device 106-3 is in an unoccupied state.

The health status 116 can indicate whether the test device 106 is healthy. Healthy means that the device can work normally and provide the required performance and functions, and there is no obvious hardware or software failure, so as to support the normal execution of the test case 112 thereon. For example, the health status 116 may be formed by multiple bits, some of which indicate the hardware status and others indicate the software status. The multiple bits indicating the hardware status may respectively indicate, for example, a management IP status, a baseboard management controller (BMC) IP status, a storage IP status, a port connection status, a disk version support status, and the like. The multiple bits indicating the software status may respectively indicate, for example, the pre-upgrade health check status, license status, and the like. In the case where all the bits in the health status 116 indicate that the status is normal, the test device can be considered to be healthy.

The usage status 118 can indicate usage of the test device 106. For example, the usage status 118 can also be formed by multiple bits, which can respectively indicate the input-output per second (IOPS) status, the reserved status (indicating whether the current test environment is reserved), and the like. These statuses can be updated at regular intervals (e.g., 24 hours). Just because the test device 106-1 is being occupied does not mean that it is being used. In other words, the test device 106-1 may be occupied but not executing any test case. For example, in the example shown in the environment 100, the test device 106-1 is being occupied and used by the test engineer 108-1 (i.e., executing the test case 112-1), and the test device 106-2 is being occupied but not used by the test engineer 108-2 (i.e., execution of the test case 112-2 may have been completed).

In some embodiments, the computing unit 102 can monitor that the test device 106-2 is being occupied by the test engineer 108-2 but has not been used for a long time, so the test device 106-2 can be forcibly released. Then, the computing unit 102 can determine whether the test device 106-2 is healthy; and if so, it can be marked as unoccupied and healthy, and then the test engineer 108-3 can occupy the test device 106-2 to execute the test case 112-3. In this way, the test device that is occupied but has not been used for a long time can be automatically released, which can increase the mobility of the device, improve the utilization rate of the device, and improve the efficiency of the whole test team. In addition, it can also be ensured that the test device assigned to the engineer is healthy, so that the engineer does not need to apply for a redundant device to ensure that he/she can get the healthy device, thus reducing the waste of resources.

It should be noted that only three test devices, three test engineers, and three test cases are shown in FIG. 1 for brevity, but this is not intended to limit the number of test devices, test engineers, and test cases, but rather any number of test devices, test engineers, and test cases may be included.

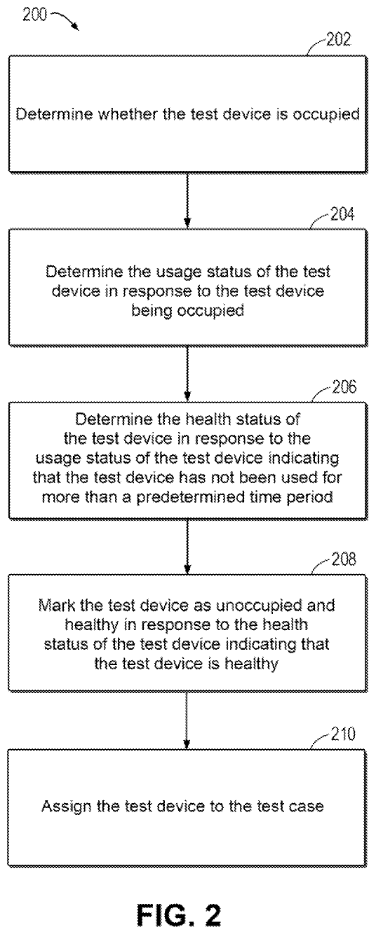

FIG. 2 shows a flowchart of a method 200 for assigning a test device according to some embodiments of the present disclosure. The method 200 may be performed by the computing unit 102 in FIG. 1, for example. As shown in FIG. 2, in block 202, the method 200 can determine whether the test device is occupied. For example, in the environment 100 shown in FIG. 1, the computing unit 102 can determine the occupancy status 114 of the test device 106-2, which may indicate that the test device 106-2 is being occupied by the test engineer 108-2. When the test device 106-2 is occupied, it can no longer be occupied by other test engineers.

In block 204, if the test device is occupied, the method 200 can determine the usage status of the test device. For example, in the environment 100 shown in FIG. 1, when the computing unit 102 determines that the test device 106-2 is being occupied, the usage status 118 of the test device 106-2 can be determined. The usage status 118 may include whether the test device 106-2 is being used, IOPS, time of use, and the like. By analyzing the usage status 118, it can be determined whether the test device 106-2 is being used and how long it has been idle when it is not used.

In block 206, if the usage status of the test device indicates that the test device has not been used for more than a predetermined time period, the method 200 can determine the health status of the test device. For example, in the environment 100 shown in FIG. 1, the computing unit 102 can determine, by analyzing the usage status 118 of the test device 106-2, that the test device 106-2 is occupied by the test engineer 108-2 but is not executing any test case at present. At this time, if the usage status 118 indicates that the test device 106-2 has not been used for more than a long period of time (e.g., 48 hours, 72 hours, etc.), the health status 116 of the test device 106-2 can be determined. The health status 116 can indicate whether the test device 106-2 can work normally and provide the required performance and function, and there is no obvious hardware or software failure.

In block 208, if the health status of the test device indicates that the test device is healthy, the method 200 can mark the test device as unoccupied and healthy. For example, in the environment 100 shown in FIG. 1, if the health status 116 of the test device 106-2 indicates that the test device 106-2 is healthy, the computing unit 102 can mark the test device 106-2 as unoccupied and healthy. All the test devices marked as unoccupied and healthy can be placed in the same test device pool, which is managed and assigned in a unified manner by the computing unit 102.

In block 210, the method 200 can assign the test devices to the test cases. For example, in the environment 100 shown in FIG. 1, the test device 106-2 is occupied by the test engineer 108-2 but not used for a long time. After determining that the test device 106-2 is healthy, the computing unit 102 can forcibly release it and assign it to the test engineer 108-3 (or to the test case 112-3).

In this way, the method 200 can automatically release the test device that is occupied but has not been used for a long time, thereby increasing the mobility of the device, improving the utilization rate of the device, and improving the efficiency of the whole test team. In addition, it can also be ensured that the test device assigned to the test engineer is healthy, so that the test engineer does not need to apply for a redundant device to ensure that he/she can get a healthy device, thus reducing the waste of resources.

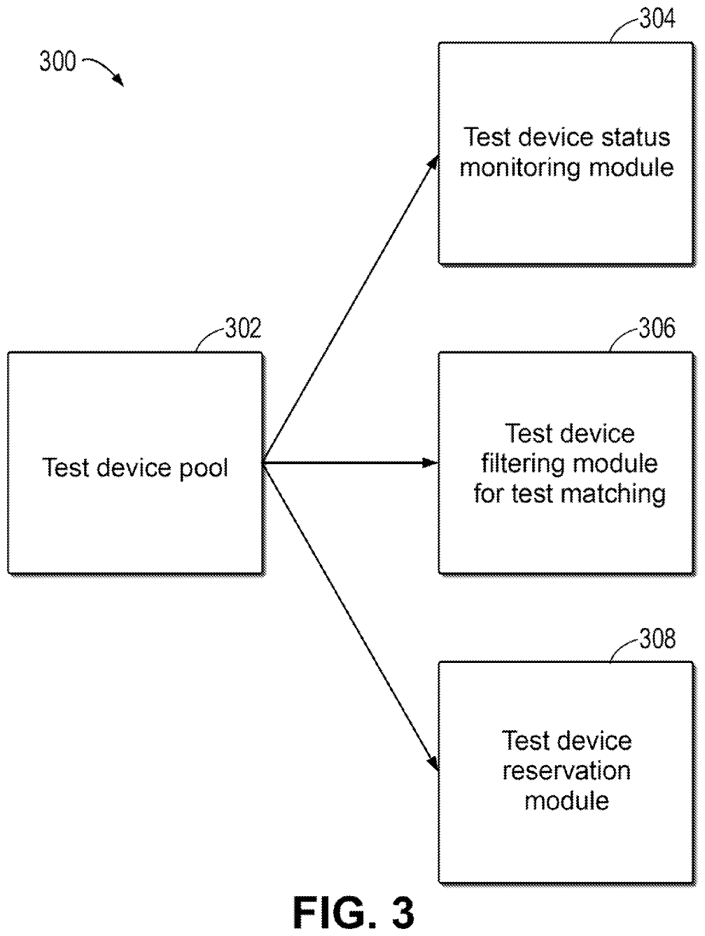

FIG. 3 shows a schematic diagram of an example architecture 300 for test device management according to some embodiments of the present disclosure. The architecture 300 includes a test device pool 302, a test device status monitoring module 304, a test device filtering module 306 for test matching, and a test device reservation module 308. For the test devices in the test device pool 302, the test device pool 302 (or a computing unit) can centrally manage their quantity, model, configuration, status, and other information. For example, the test device pool 302 can regularly update the configuration labels of the test devices therein for use by the test device filtering module 306 for test matching.

The test device status monitoring module 304 can monitor the occupancy status of a test device. For a test device that is being occupied, the test device status monitoring module 304 can monitor its usage status, for example, whether it is being used, how long it has not been used, and so on. For a test device that is not occupied, the test device status monitoring module 304 can monitor its health status, for example, whether there is a hardware failure or a software failure, whether the port connection is normal, and so on. By monitoring the occupancy status, usage status, and health status, the test device status monitoring module 304 enables the timely repair of the faulty (or unhealthy) test device, remind the test engineer who has occupied the test machine for a long time without using it, and release the test machine that has been occupied for a long time but has not been used. As such, the test device status monitoring module 304 can ensure that the test device resources are well maintained and enable a test engineer to use the required test device in time.

The test device filtering module 306 for test matching can manage the configuration demand labels of the test cases, and can also match the configuration labels of the test devices with the configuration demand labels of the test cases to determine that a certain test device can execute which test cases and a certain test case can be executed by which test devices. The matching results can be updated regularly and stored in a table for use by the test device reservation module 308. In addition, the test device filtering module 306 for test matching can also determine a device impact factor of each test device based on the test case to be executed on the test device, and the device impact factor can indicate the level of impact of the test case to be executed on the test device on the availability of the test device, so that scarce device resources (e.g., device resources with special configuration) can be used by the engineer who needs it most.

The test device reservation module 308 can manage reservations of test devices. When many test engineers want to use a test device with a specific configuration during the project test, they don't know that others also need the test device with this configuration. As the engineers usually don't make planning for the test machines that need to be applied for at the beginning of the test cycle, they won't find that many engineers are queuing up, waiting to use the test device until the project deadline approaches, which seriously affects the timely completion of the project. In view of this, the test device reservation module 308 can support the reservation of the matching test device based on the test case. Compared with the approach in which a test engineer fills in his/her own name or job number to reserve the designated test device, the test device reservation module 308 can receive the name or identifier of the test case, and then determine the test device matching with this test case through the test device filtering module 306 for test matching, and can put the test case in queues for reserving multiple matching test devices. Once any of the reserved test devices is released and it is the turn of the test case, the released test device can be assigned to the test case and its test engineer. In this way, the degree of matching between the reserved test device and the test case can be improved, and more test devices can be reserved at the same time, thus reducing the time of queuing up and waiting and improving the test efficiency.

In some embodiments, if the usage status of the test device indicates that the test device has not been used for a time period that is greater than a short predetermined time period but less than a long predetermined time period, a reminder to release the test device can be sent to the occupant of the test device. In some embodiments, in order to assign a test device to a test case, it can be determined whether there are candidate test cases requesting to occupy the test device, and if there are candidate test cases requesting to occupy the test device, the test device can be assigned to the test case with the highest priority among the candidate test cases. In some embodiments, if there are no candidate test cases requesting to occupy the test device, a matching test case that matches with the test device can be determined, and a notification that the test device is available can be sent to an owner of the matching test case.

In some embodiments, in order to determine a matching test case that matches with a test device, a configuration label for each of the multiple test devices and a configuration demand label for each of the multiple test cases can be determined. Then, a test-device-to-test-case matching table (also called a first matching table) can be generated based on the configuration labels and the configuration demand labels, and the entries in the matching table include a specific test device and a list of test cases that match with the specific test device. Then, the matching test case can be determined based on the test device and the matching table.

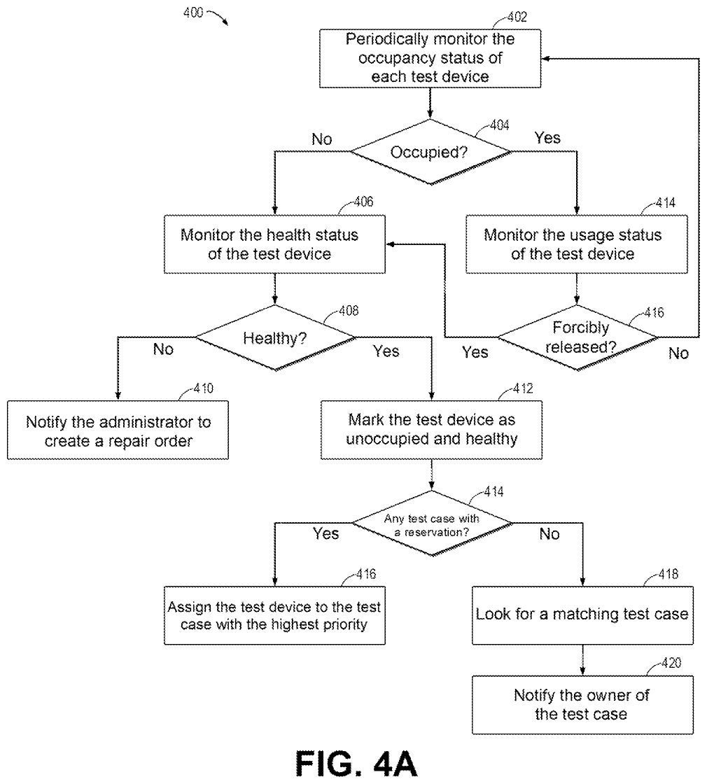

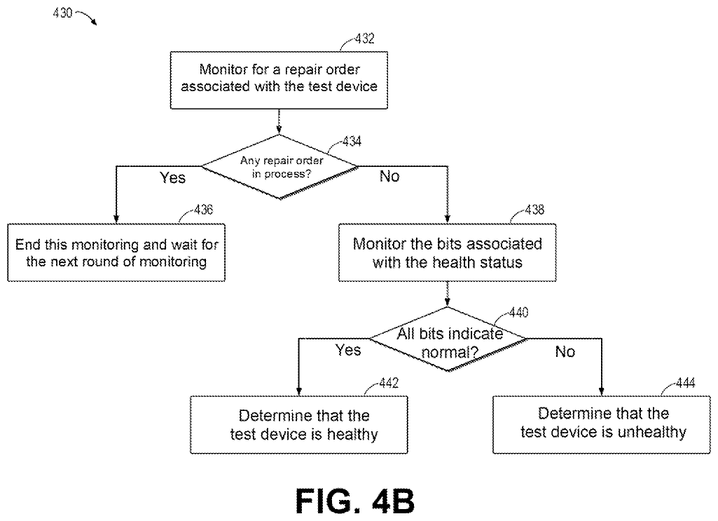

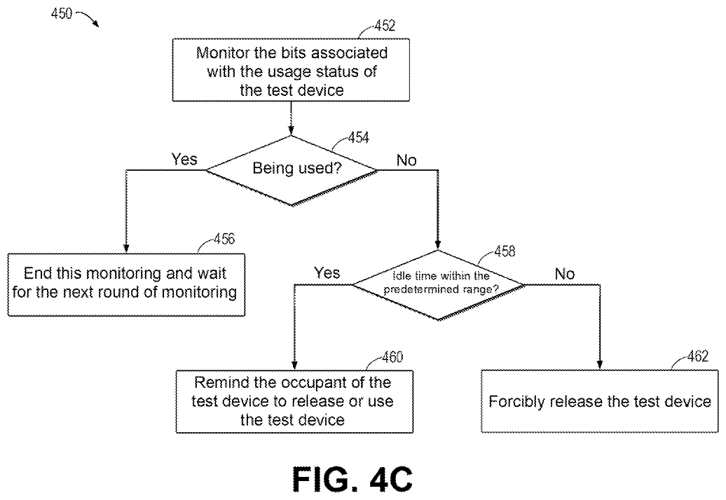

FIGS. 4A to 4C show flowcharts of an example process of monitoring the status of the test device by the test device status monitoring module according to some embodiments of the present disclosure, in which FIG. 4A shows a flowchart of a main process 400 of monitoring the status of the test device according to some embodiments of the present disclosure, FIG. 4B shows a flowchart of a process 430 of monitoring the health status of the test device according to some embodiments of the present disclosure, and FIG. 4C shows a flowchart of a process 450 of monitoring the usage status of the test device according to some embodiments of the present disclosure.

As shown in FIG. 4A, in block 402, the test device monitoring module can periodically monitor the occupancy status of each test device in the test device pool. In block 404, if the test device is not occupied, the process 400 proceeds to block 406. In block 406, the test device monitoring module can monitor the health status of the test device. In block 408, the test device monitoring module can determine whether the test device is healthy. For example, it can be determined whether the test device is healthy by checking whether all bits of the health status indicate that the status is normal. If the health status of the test device indicates that it is unhealthy, the process 400 proceeds to block 410. In block 410, the test device monitoring module can notify a system administrator to create a repair order for the test device. In this way, the system administrator can know which test device fails in time, so that the device can be repaired as soon as possible to increase the available resources in the test device pool. Returning to block 408, if the health status of the test device indicates that it is healthy, the process 400 proceeds to block 412. In block 412, the test device monitoring module can mark the test device as unoccupied and healthy. In this way, when the test engineer applies for or reserves the test device, he/she can clearly know that the test device that will be assigned to him/her in the future is healthy, thus avoiding the case where the engineer submits a redundant application for fear of being assigned with a faulty device when applying for or reserving the test device, thereby reducing the waste of resources.

Returning to block 404, if the test device is being occupied, the process 400 proceeds to block 414. In block 414, the test device monitoring module can monitor the usage status of the test device. For example, if the test device is occupied by a test engineer but has not been used for a long time (e.g., it has not been used for more than a predetermined time period), the test device monitoring module can forcibly release the test device. If the test device is being used or not used only for a short time, the test device monitoring module will not forcibly release the test device. In block 416, the test device monitoring module can determine whether the test device is forcibly released. If the test device is forcibly released, its occupancy status is set to unoccupied, and then the process 400 proceeds to block 406 to check whether it is healthy. If the test device is healthy, it can be marked as unoccupied and healthy. If the test device is not forcibly released, the process 400 returns to block 402 to wait for the next round of monitoring. In this way, those test devices that are occupied but are not used for a long time can be automatically and forcibly released by the system, so that other test cases or test engineers can use the test devices, thereby increasing the utilization rate of the test devices.

In block 414, the test device monitoring module can determine whether there is a test case that has reserved a test device that is marked as unoccupied and healthy queuing up to wait to use the test device (e.g., determined by the test device reservation module). If there are such test cases queuing up to wait to use the test device, the process 400 proceeds to block 416. In block 416, the test device monitoring module can assign the test device to the test case with the highest priority (for example, the test case ranked first in the queue) among the multiple test cases in the queue. When only one test case is included in the queue, the test device can be assigned to the test case. In this way, when the test device is marked as unoccupied and healthy, it can be assigned in time to the test case that has reserved the test device, thus improving efficiency.

Returning to block 414, if there is no test case that has reserved the test device, the process 400 proceeds to block 418. In block 418, the test device monitoring module can search for all test cases that match with the test device marked as unoccupied and healthy. In some embodiments, the test device monitoring module can query the test-device-to-test-case matching table that is updated and maintained by the test device filtering module for test matching to determine whether there is a matching test case. In the test-device-to-test-case matching table, each test device is associated with a set of test cases that match with its configuration. The test-device-to-test-case matching table can be determined based on the configuration labels of the test devices and the configuration demand labels of the test cases. As the test-device-to-test-case matching table is created in advance and updated regularly, the efficiency of finding matching test cases can be improved and the computing resources can be saved.

In block 420, the test device monitoring module can send a notification to engineers for all test cases matching with this test device to inform them that the test device is currently unoccupied and healthy. Upon receiving the notification, the test engineers can request in time to occupy the test device, and the test engineers can determine that the test device is healthy and it is unnecessary to apply for a redundant test device. In this way, test resources can be acquired in time regardless of whether it is a test case that has reserved the test device or a test case that has not reserved the test device but can match with the test device, thus improving the efficiency and ensuring that the test task is completed on time.

FIG. 4B shows a flowchart of a process 430 of monitoring the health status of the test device according to some embodiments of the present disclosure. As shown in FIG. 4B, in block 432, the test device monitoring module can monitor a repair order associated with the test device. In block 434, if there is a repair order in process associated with the test device, it means that the test device is known to have a fault, so the process 430 proceeds to block 436. In block 436, the test device monitoring module can end this monitoring process for the test device and wait for the next round of monitoring. Returning to block 434, if there is no repair order in process associated with the test device, the process 430 proceeds to block 438. In block 438, the test device monitoring module can monitor bits associated with the health status of the test device. In block 440, if all bits associated with the health status of the test device (e.g., including multiple bits indicating the hardware status and multiple bits indicating the software status) indicate that the status is normal, it can be determined that the test device is healthy (block 442). If any bit associated with the health status indicates that the status is abnormal, it can be determined that the test device is unhealthy (block 444). In this way, it can be determined whether the test device is healthy, and the administrator can be informed in time to create a repair order for the unhealthy device, and the healthy device can be assigned in time to the test case that has reserved or matches with the device, thus improving the circulation speed of the test device.

FIG. 4C shows a flowchart of a process 450 of monitoring the usage status of the test device according to some embodiments of the present disclosure. In block 452, the test device monitoring module can monitor bits associated with the usage status of the test device (e.g., IOPS status, reservation status, etc.). In block 454, the test device monitoring module can determine whether the test device is being used. If the test device is currently not being used but has not been used only for a time period no longer than a short time period threshold (e.g., 24 hours), the test device can also be considered as being used. If the test device is being used, one can end this monitoring and wait for the next round of monitoring (block 456). If the device is not being used, the process 450 proceeds to block 458. In block 458, the test device monitoring module can determine whether the idle time of the device is within a predetermined range, for example, longer than a small time threshold and shorter than a large time threshold (e.g., between 24 hours and 72 hours). If the idle time of the device is within the predetermined range, a notification can be automatically sent to the engineer occupying the device to remind him/her to release or use the test device in time (block 460). If the idle time of the device has exceeded a large time threshold (e.g., more than 72 hours), the test device can be automatically and forcibly released (block 462). In this way, the occupier of the test device can be reminded to manually release or continue to use the device when he/she has finished using the test device but forgets to release it, and the device can be automatically and forcibly released when the device has not been used for a long time, thus reducing the idle time of the device and improving the utilization rate of the device.

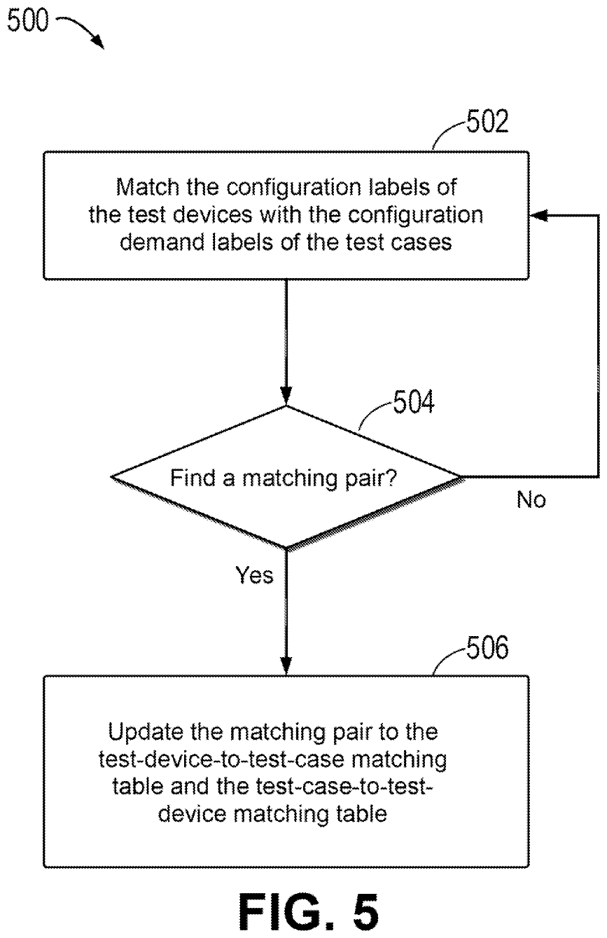

In some embodiments, the configuration labels of the test devices and the test demand labels of the test cases can be determined, and then the test-device-to-test-case matching table (also called the first matching table) and the test-case-to-test-device matching table (also called the second matching table) can be updated based on the configuration labels of the test devices and the test demand labels of the test cases. FIG. 5 shows a flowchart of an example process 500 of matching test devices and test cases by a test device filtering module for test matching according to some embodiments of the present disclosure. As shown in FIG. 5, in block 502, the test device filtering module can determine the configuration labels of the test devices and the configuration demand labels of the test cases, and match the configuration labels of the test devices with the configuration demand labels of the test cases. For example, the configuration labels of the test devices can include the number of disk array enclosures (DAEs), platform mode, whether to support background interface, whether to support power operation, whether to support a specific database, whether to support human-computer interaction, whether to support the same virtual local area network (VLAN), and the like. The configuration demand labels of the test cases correspond to the configuration labels of the test devices. If the configuration label of the test device can contain all the configuration demand labels of the test case, it can be determined that the test device matches with the test case.

In block 504, if the test device filtering module can find a matching test device and test case pair, the process 500 can proceed to block 506. In block 506, the test device filtering module can update the test-device-to-test-case matching table and the test-case-to-test-device matching table based on the matching test device and test case pairs. In the test-device-to-test-case matching table, each test device is associated with a set of test cases (or a test case list), which represents all test cases that the test device can execute. In the test-case-to-test-device matching table, each test case is associated with a set of test devices (or a test device list), which represents all test devices that can execute the test case. The test device filtering module can keep these two matching tables updated in real time. In some embodiments, these two matching tables can be used in the pre-test planning phase or when rescheduling in the middle of the test cycle.

In this way, the test filtering module for test matching can maintain the test-device-to-test-case matching table and the test-case-to-test-device matching table based on the configurations of the test devices and the configuration demands of the test cases, so that the two matching tables can be used to find a matching test case when a test device is idle, or to find a matching test device when reserving a test device for the test case. In this way, the search results can be more comprehensive, and the search speed can be improved, thereby saving computing resources.

In some embodiments, if a reservation request for a test case is received, a matching test device that matches with the test case is determined. Then, a test device can be assigned to the test case based on the matching test device. In some embodiments, in order to determine the matching test devices that match with the test cases, a configuration label for each of the multiple test devices and a configuration demand label for each of the multiple test cases can be determined. Then, a test-device-to-test-case matching table can be generated based on the configuration labels and the configuration demand labels, and the entries in the matching table include a specific test case and a list of test devices matching with the specific test case. Then, the matching test device can be determined based on the test case and the matching table. In some embodiments, in order to assign a test device for a test case, an available test device that is unoccupied and healthy among matching test devices can be determined. Then, if there is no available test device, at least one test device can be reserved for the test case based on the configuration demand label of the test case. In some embodiments, if there are multiple available test devices, the target test device with the smallest device impact factor among the multiple available test devices can be determined based on the test-device-to-test-case matching table, the device impact factor indicating the degree of impact of the test case to be executed on the specific test device on the availability of the specific test device. Then, the target test device can be assigned to the test case.

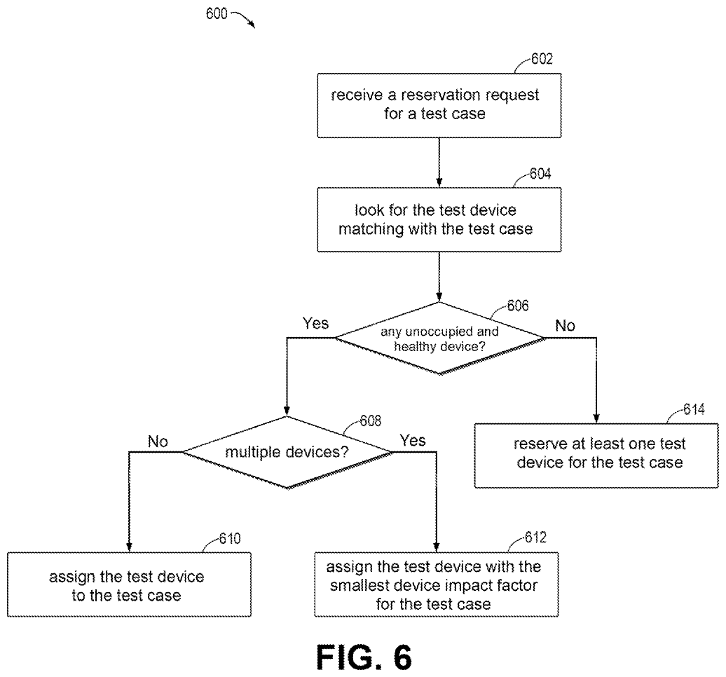

FIG. 6 shows a flowchart of an example process 600 of handling a reservation request by a test device reservation module according to some embodiments of the present disclosure. As shown in FIG. 6, in block 602, the test device reservation module can receive a reservation request for a test case. The reservation request may include the name or identifier of the test case. In block 604, the test device reservation module can search for the test device that matches with the test case. For example, the test device reservation module can look up the test-case-to-test-device matching table based on the name or identifier of the test case (e.g., through the test device filtering module for test matching) to determine all test devices that can execute the test case. In block 606, the test device reservation module can determine whether there is an unoccupied and healthy test device among the test devices that match with the test case, and if so, the process 600 proceeds to block 608. In block 608, the test device reservation module can determine whether there are multiple matching test devices that are unoccupied and healthy. If there is only one such device, the test device can be directly assigned to the test case corresponding to the reservation request (block 610). If there are multiple such devices, the test device with the smallest device impact factor can be assigned to the test case corresponding to the reservation request (block 612).

The device impact factor indicates a degree to which the test case to be executed on a specific test device impacts the availability of the specific test device. In some embodiments, in order to determine the device impact factor of a test device, the number of test cases to be executed on a test device among multiple available test devices can be determined. Then, the number of test cases to be executed can be determined as the device impact factor of the test device. In this way, the more test cases to be executed on the test device, the greater the device impact factor of the test device. In some embodiments, the total execution duration of test cases to be executed on a test device among multiple available test devices can be determined. Then, the total execution duration of the test cases to be executed can be determined as the device impact factor of the test device. In this way, although the number of test cases to be executed on a certain test device is small, their total execution duration is long, so the device impact factor is also large, which facilitates improving the accuracy of the device impact factor. By assigning the test device with the smallest device impact factor to the test case corresponding to the reservation request, it can be ensured that the scarcest device resources are used for the test case that needs the device most, thus maximizing the utilization rate of the test device.

Returning to block 606, if there is no unoccupied and healthy test device that matches with the test case, the process 600 proceeds to block 614. In block 614, the test device reservation module can reserve at least one test device for the test case. For example, the test device reservation module can reserve multiple matching test devices for the test case based on the test-case-to-test-device matching table. Compared with the approach in which a test engineer fills in his/her own name or job number to reserve a designated test device, the reservation request received by the test device reservation module may include the name or identifier of the test case, and then the test device reservation module can reserve multiple test devices for the test case based on the test-case-to-test-device matching table. In this way, the test engineer can be prevented from manually specifying the device to be reserved, but rather the device that meets the requirements can be automatically reserved based on the configuration of the test case, thus improving the matching degree and comprehensiveness of the reservation, speeding up the acquisition of the reserved resources, and also reducing the waste of resources.

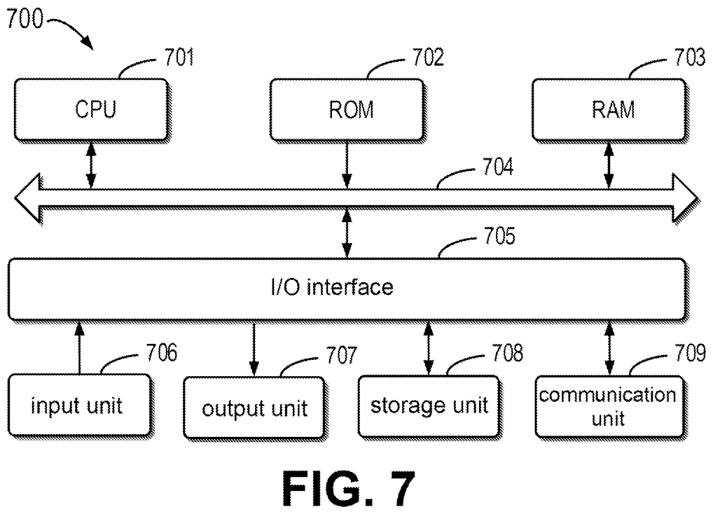

FIG. 7 shows a block diagram of an example device 700 which can be used to implement embodiments of the present disclosure. For example, the computing unit 102 shown in FIG. 1 may be the example device 700 as shown in FIG. 7. As shown in the figure, the device 700 includes a computing unit 701 that can perform various appropriate actions and processing according to computer program instructions stored in a read-only memory (ROM) 702 or computer program instructions loaded from a storage unit 708 to a random access memory (RAM) 703. Various programs and data required for the operation of the device 700 may also be stored in the RAM 703. The computing unit 701, the ROM 702, and the RAM 703 are connected to each other via a bus 704. An Input/Output (I/O) interface 705 is also connected to the bus 704.

Multiple components in the device 700 are connected to the I/O interface 705, including: an input unit 706, such as a keyboard, a mouse, and the like; an output unit 707, such as various types of displays, speakers, and the like; the storage unit 708, such as a magnetic disk, an optical disc, and the like; and a communication unit 709, such as a network card, a modem, a wireless communication transceiver, and the like. The communication unit 709 allows the device 700 to exchange information/data with other devices via a computer network, such as the Internet, and/or various telecommunication networks.

The computing unit 701 may be various general-purpose and/or special-purpose processing components with processing and computing powers. Some examples of the computing unit 701 include, but are not limited to, central processing units (CPUs), graphics processing units (GPUs), various specialized artificial intelligence (AI) computing chips, various computing units for running machine learning model algorithms, digital signal processors (DSPs), and any appropriate processors, controllers, microcontrollers, and the like. The computing unit 701 performs various methods and processes described above, such as the method 200. For example, in some embodiments, the method 200 may be implemented as a computer software program that is tangibly included in a machine readable medium, such as the storage unit 708. In some embodiments, part or all of the computer program may be loaded and/or installed onto the device 700 via the ROM 702 and/or the communication unit 709. When the computer program is loaded to the RAM 703 and executed by the computing unit 701, one or more steps of the method 200 described above may be performed. Alternatively, in other embodiments, the computing unit 701 may be configured to implement the method 200 in any other suitable manners (such as by means of firmware).

The functions described herein may be executed at least in part by one or more hardware logic components. For example, without limitation, example types of hardware logic components that can be used include: a Field Programmable Gate Array (FPGA), an Application Specific Integrated Circuit (ASIC), an Application Specific Standard Product (ASSP), a System on Chip (SOC), a Complex Programmable Logic Device (CPLD), and the like.

Program codes for implementing the method of the present disclosure may be written by using one programming language or any combination of multiple programming languages. The program codes may be provided to a processor or controller of a general purpose computer, a special purpose computer, or another programmable data processing apparatus, such that the program codes, when executed by the processor or controller, implement the functions/operations specified in the flowcharts and/or block diagrams. The program codes may be executed completely on a machine, executed partially on a machine, executed partially on a machine and partially on a remote machine as a stand-alone software package, or executed completely on a remote machine or server.

In the context of the present disclosure, a machine-readable medium may be a tangible medium that may include or store a program for use by an instruction execution system, apparatus, or device or in connection with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include one or more wire-based electrical connections, a portable computer diskette, a hard disk, a RAM, a ROM, an erasable programmable read-only memory (EPROM or flash memory), an optical fiber, a portable compact disc read-only memory (CD-ROM), an optical storage device, a magnetic storage device, or any suitable combinations thereof.

Additionally, although operations are depicted in a particular order in the figures, this should not be construed as an indication that such operations are required to be performed in the particular order shown or in a sequential order, or that all illustrated operations should be performed to achieve desirable results. Under certain environments, multitasking and parallel processing may be advantageous. Likewise, although the above discussion contains several specific implementation details, these should not be construed as limitations to the scope of the present disclosure. Certain features that are described in the context of separate embodiments may also be implemented in combination in a single implementation. Conversely, various features that are described in the context of a single implementation may also be implemented in multiple implementations separately or in any suitable sub-combination.

Although the present subject matter has been described using a language specific to structural features and/or method logical actions, it should be understood that the subject matter defined in the appended claims is not necessarily limited to the particular features or actions described above. Rather, the specific features and actions described above are merely example forms of implementing the claims.

1. A method for assigning a test device, comprising:
determining whether the test device is occupied;
determining a usage status of the test device in response to the test device being occupied;
determining a health status of the test device in response to the usage status of the test device indicating that the test device has not been used for more than a predetermined time period;
marking the test device as unoccupied and healthy in response to the health status of the test device indicating that the test device is healthy; and
assigning the test device to a test case.

2. The method according to claim 1, wherein the predetermined time period is a first predetermined time period, and the method further comprises:
sending, to an occupant of the test device, a reminder to release the test device in response to the usage status of the test device indicating that the test device has not been used for a time period that is shorter than the first predetermined time period and longer than a second predetermined time period.

3. The method according to claim 1, wherein assigning the test device to the test case comprises:
determining whether there are candidate test cases requesting to occupy the test device; and
assigning the test device to a test case with the highest priority among the candidate test cases in response to there being the candidate test cases requesting to occupy the test device.

4. The method according to claim 3, wherein assigning the test device to the test case further comprises:
determining a matching test case that matches with the test device in response to there being no candidate test case requesting to occupy the test device; and
sending, to an owner of the matching test case, a notification that the test device is available.

5. The method according to claim 4, wherein determining the matching test case that matches with the test device comprises:
determining a configuration label for each test device of a plurality of test devices and a configuration demand label for each test case of a plurality of test cases;
generating a test-device-to-test-case first matching table based on the configuration label and the configuration demand label, entries in the test-device-to-test-case first matching table comprising a specific test device and a list of test cases matching with the specific test device; and
determining the matching test case based on the test device and the test-device-to-test-case first matching table.

6. The method according to claim 1, further comprising:
determining a matching test device that matches with the test case in response to receiving a reservation request for the test case; and
assigning the test device for the test case based on the matching test device.

7. The method according to claim 6, wherein determining the matching test device that matches with the test case comprises:
determining a configuration label for each test device of a plurality of test devices and a configuration demand label for each test case of a plurality of test cases;
generating a test-case-to-test-device second matching table based on the configuration label and the configuration demand label, entries in the test-case-to-test-device second matching table comprising a specific test case and a list of test devices matching with the specific test case; and
determining the matching test device based on the test case and the test-case-to-test-device second matching table.

8. The method according to claim 7, wherein assigning the test device for the test case based on the matching test device comprises:
determining an available test device that is unoccupied and healthy among one or more matching test devices; and
reserving at least one test device for the test case based on the configuration demand label of the test case in response to there being no available test device.

9. The method according to claim 8, further comprising:
determining a target test device with the smallest device impact factor among a plurality of available test devices based on the test-case-to-test-device second matching table in response to determining the plurality of available test devices, the device impact factor indicating a level of impact of a test case to be executed on a specific test device on the availability of the specific test device; and
assigning the target test device to the test case.

10. The method according to claim 9, wherein determining the target test device with the smallest device impact factor among the plurality of available test devices based on the test-case-to-test-device second matching table comprises:
determining a number of test cases to be executed on a first test device among the plurality of available test devices; and
determining the number of the test cases to be executed as a device impact factor of the first test device.

11. The method according to claim 9, wherein determining the target test device with the smallest device impact factor among the plurality of available test devices based on the test-case-to-test-device second matching table comprises:
determining a total execution duration of test cases to be executed on a second test device among the plurality of available test devices; and
determining the total execution duration of the test cases to be executed as the device impact factor of the second test device.

12. An electronic device, comprising:
at least one processor; and
a memory coupled to the at least one processor and having instructions stored therein, the instructions, when executed by the at least one processor, causing the electronic device to perform actions comprising:
determining whether a test device is occupied;
determining a usage status of the test device in response to the test device being occupied;
determining a health status of the test device in response to the usage status of the test device indicating that the test device has not been used for more than a predetermined time period;
marking the test device as unoccupied and healthy in response to the health status of the test device indicating that the test device is healthy; and
assigning the test device to a test case.

13. The electronic device according to claim 12, wherein the predetermined time period is a first predetermined time period, and the actions further comprise:
sending, to an occupant of the test device, a reminder to release the test device in response to the usage status of the test device indicating that the test device has not been used for a time period that is shorter than the first predetermined time period and longer than a second predetermined time period.

14. The electronic device according to claim 12, wherein assigning the test device to the test case comprises:
determining whether there are candidate test cases requesting to occupy the test device; and
assigning the test device to a test case with the highest priority among the candidate test cases in response to there being the candidate test cases requesting to occupy the test device.

15. The electronic device according to claim 14, wherein assigning the test device to the test case further comprises:
determining a matching test case that matches with the test device in response to there being no candidate test case requesting to occupy the test device; and
sending, to an owner of the matching test case, a notification that the test device is available.

16. The electronic device according to claim 15, wherein determining the matching test case that matches with the test device comprises:
determining a configuration label for each test device of a plurality of test devices and a configuration demand label for each test case of a plurality of test cases;
generating a test-device-to-test-case first matching table based on the configuration label and the configuration demand label, entries in the test-device-to-test-case first matching table comprising a specific test device and a list of test cases matching with the specific test device; and
determining the matching test case based on the test device and the test-device-to-test-case first matching table.

17. The electronic device according to claim 12, wherein the actions further comprise:
determining a matching test device that matches with the test case in response to receiving a reservation request for the test case; and
assigning the test device for the test case based on the matching test device.

18. The electronic device according to claim 17, wherein determining the matching test device that matches with the test case comprises:
determining a configuration label for each test device of a plurality of test devices and a configuration demand label for each test case of a plurality of test cases;
generating a test-case-to-test-device second matching table based on the configuration label and the configuration demand label, entries in the test-case-to-test-device second matching table comprising a specific test case and a list of test devices matching with the specific test case; and
determining the matching test device based on the test case and the test-case-to-test-device second matching table.

19. The electronic device according to claim 18, wherein assigning the test device for the test case based on the matching test device comprises:
determining an available test device that is unoccupied and healthy among one or more matching test devices; and
reserving at least one test device for the test case based on the configuration demand label of the test case in response to there being no available test device.

20. A computer program product, the computer program product being tangibly stored on a non-transitory computer-readable medium and comprising machine-executable instructions, the machine-executable instructions, when executed by a machine, causing the machine to perform actions comprising:
determining whether a test device is occupied;
determining a usage status of the test device in response to the test device being occupied;
determining a health status of the test device in response to the usage status of the test device indicating that the test device has not been used for more than a predetermined time period;
marking the test device as unoccupied and healthy in response to the health status of the test device indicating that the test device is healthy; and
assigning the test device to a test case.
